(19) United States
(12) Patent Application Publication
(10) Pub. No.: US 2012/0045594 A1
(43) Pub. Date: Feb. 23, 2012

(54) OUTSTANDINGLY ABRASION RESISTANT AND POLLUTION RESISTANT COATING COMPOSITION AND COATING FILM

(75) Inventors: Yeong-Rae Chang, Yuseong-gu (KR); Joon-Koo Kang, Seo-gu (KR); Kyung-Ki Hong, Cheongwon-gun (KR); Soon-Hwa Jung, Yuseong-gu (KR); Hye-Min Kim, Seo-gu (KR); Soo-Kyoung Lee, Cheongju-si (KR); Eun-Sang Yoo, Cheongwongun (KR); Sung-Su Kim, Cheongwon-gun (KR); Young-Jun Hong, Seo-gu (KR); Ju-Young Kim, Daedeokk-gu (KR)

(73) Assignee: LG CHEM, LTD., Seoul (KR)

(21) Appl. No.: 13/215,885

(22) Filed: Aug. 23, 2011

Related U.S. Application Data
(63) Continuation of application No. PCT/KR2010/001261, filed on Feb. 26, 2010.

(30) Foreign Application Priority Data
Feb. 27, 2009 (KR) 10-2009-0017229
Feb. 26, 2010 (KR) 10-2010-0017432

(51) Int. Cl. B32B 27/06; B32B 23/04; B05D 3/06; B32B 9/04; H01B 1/20; B32B 33/00; C09K 19/58; B82Y 30/00

(52) U.S. Cl. 428/1.4; 428/339; 428/480; 428/500; 428/522; 428/532; 427/508; 428/411.1; 252/519.31; 977/773; 977/952

(57) ABSTRACT

The present invention provides a coating composition and a coating film, which comprises a) a binder resin containing a UV-curable functional group; b) a compound containing a fluorine UV-curable functional group; c) a photoinitiator; d) nano-sized particles; and e) conductive inorganic particles.

### TECHNICAL FIELD

The present invention relates to a coating composition and a coating film that are capable of being applied to displays such as TVs, monitors for computers, laptops or laptop computers, mobile phones and the like. More particularly, the present invention relates to a coating composition and a coating film that have excellent abrasion resistance, and excellent contamination resistance such as fingerprint trace removability and scribbling resistance to easily remove contaminants of oil components such as fingerprints or scribbles, and in particular, excellent dust removability.

This application claims priority from Korean Patent Application Nos. 10-2009-0017229 and 10-2010-0017432 filed on Feb. 27, 2009 in the Korean Intellectual Property Office, the disclosure of which is incorporated herein by reference in its entirety.

### BACKGROUND ART

In the case of various displays, there are problems in that an image is easily deformed or the quality of appearance is reduced by fingerprints. To solve the problems, fluorine-containing surface treatment agents can be used to prepare a coating composition and a coating film having excellent contamination resistance. However, upon abrasion or friction, these fluorine-containing surface treatment agents generate static electricity to deteriorate dust removability or abrasion resistance.

In the related art, some methods for realizing the surface treatment to provide hard coating films with conductivity have been suggested as follows.

As a first method, there is a method for coating a substrate with an antistatic layer applied with conductive inorganic particles, and coating with a hard coating layer consecutively. At this time, the applied antistatic layer has a thickness of 0.1 to 1.0 μm and the hard coating layer has a thickness of 1 to several tens μm. The hard coating layer is required to have abrasion resistance, and the antistatic layer should not deteriorate the light transmission. However, lamination of the above two layers is difficult to satisfy all of antistatic property, abrasion resistance, and light transmission.

As a second method, there is a method for providing the hard coating layer simultaneously with antistatic property. Conductive inorganic particles are dispersed in a hard coating solution containing an acrylate or silicone resin to impart both abrasion resistance and antistatic properties in a single application. At this time, the conductive inorganic particles should have a diameter of 100 nm or less to prevent a reduction in light transmission and haze growth. In addition, the weight ratio of conductive inorganic particles and resins has to be properly controlled. If the weight ratio of conductive inorganic particles is high, haze growth or reduction in abrasion resistance occurs. If the weight ratio of conductive inorganic particles is low, the sufficient antistatic property may not be achieved.

### DISCLOSURE

### Technical Problem

Therefore, an object of the present invention is to provide a coating composition and a coating film that are capable of simultaneously providing abrasion resistance and contamination resistance by a single coating method, maintaining properties of abrasion resistance and contamination resistance while a film is rubbed, and having excellent dust removability and antistatic property.

### Technical Solution

The present invention provides a coating composition that comprises a) a binder resin containing a UV-curable functional group; b) a compound containing a fluorine UV-curable functional group; c) a photoinitiator; d) nano-sized particles; and e) conductive inorganic particles.

Further, the present invention provides a coating film prepared by using the coating composition according to the present invention, which comprises a) a binder resin containing a UV-curable functional group; b) a compound containing a fluorine UV-curable functional group; c) a photoinitiator; d) nano-sized particles; and e) conductive inorganic particles.

Further, the present invention provides a method for producing a coating film, comprising the steps of coating the coating composition according to the present invention on a substrate; and drying and photocuring the coated coating composition.

Further, the present invention provides a display device that includes the coating film according to the present invention.

### Advantageous Effects

According to the present invention, provided are a coating composition and a coating film that have excellent abrasion resistance, and excellent contamination resistance such as fingerprint trace removability and scribbling resistance to easily remove contaminants of oil components such as fingerprints or scribbles, and in particular, excellent dust removability.

In addition, the coating film can be provided with both abrasion resistance and contamination resistance by a single coating method of the coating composition according to the present invention, and the properties of abrasion resistance and contamination resistance can be maintained while the coating film according to the present invention is rubbed.

### BEST MODE

Hereinafter, a better understanding of the present invention may be obtained in light of the following Examples which are set forth to illustrate, but are not to be construed to limit the present invention.

In the present Example, as described below, after the coating composition and the coating film were produced, physical properties of abrasion resistance, fingerprint trace removability, scribbling resistance and surface energy were evaluated by using the following method.

The abrasion resistance of the coating film was evaluated by pencil hardness at 500 g load.

The fingerprint trace removability of the coating film was evaluated by using the following method. An artificial fingerprint solution was produced and applied to a rubber stamp. Next, the rubber stamp was pressed on the surface of the coating film and dried for 10 min. Subsequently, the fingerprint was removed from the coating film by using a gauze towel and the remaining fingerprint was evaluated by the naked eye. At this time, the used artificial fingerprint solution was prepared by JIS K 2246.

In respects to the scribbling resistance of the coating film, the pen mark was examined by the naked eye after two 5 cm lines were drawn by using the oily pen and wiped using the very fine fiber dustless cloth. This procedure was repeated until the pen mark was observed, and the number of repetition was recorded.

The surface energy was evaluated by measuring the contact angle of water and diiodomethane using DSA 100 manufactured by KRUSS.

### Example 1

100 g of dipentaerythritol hexaacrylate, 10 g of a perfluoro group-containing monofunctioanl acrylate having the structure of Formula 1 (X=F, Y=F, Z=H, h=6, i=1, free of other components), 5 g of the photoinitiator Irgacure 184, 10 g of the silica particles, having the average particle diameter of 20 nm, that were subjected to surface treatment with methacryloxy propyltrimethoxy silane, 10 g of antimony doped zinc oxide (AZO, manufactured by Nissan, particle diameter of about 20 nm), and 100 g of methyl ethyl ketone were mixed with each other, and the coating composition was agitated for about 1 hr so that they were sufficiently mixed with each other. The coating composition that was produced by using the above method was subjected to 2-roll reverse coating so that the curing thickness was 10 μm on the triacetylcellulose film. The coated film was dried at 60° C. in an oven for 2 min, and UV energy was irradiated thereon in the intensity of 1 J/cm² using the polymerization mercury lamp to produce the abrasion resistant coating film that had the fingerprint trace removability.

### Example 2

The coating film was produced in the same manner as Example 1, except for using 20 g of antimony doped zinc oxide (AZO, manufactured by Nissan, particle diameter of about 20 nm) used in Example 1.

### Example 3

The coating film was produced in the same manner as Example 1, except for using 20 g of tin oxide (manufactured by Nissan, particle diameter of about 20 nm) instead of antimony doped zinc oxide.

### Example 4

The coating film was produced in the same manner as Example 1, except for using 20 g of tin-doped indium oxide (ITO, manufactured by AMP, particle diameter of about 100 nm) instead of antimony doped zinc oxide.

### Comparative Example 1

The coating film was produced in the same manner as Example 1, except for not using antimony doped zinc oxide (AZO) used in Example 1.

### Comparative Example 2

The coating film was produced in the same manner as Example 1, except for using 100 g of antimony doped zinc oxide (AZO) used in Example 1.

### Comparative Example 3

The coating film was produced in the same manner as Example 1, except for not using silica.

### Comparative Example 4

The coating film was produced in the same manner as Example 1, except for using approximately 0.5 g of antimony doped zinc oxide (AZO) used in Example 1.

The surface resistivity, pencil hardness, the fingerprint trace removability, surface energy and scribbling resistance of the coating film that was produced by the above method were evaluated. The evaluated results are described in the following Table 1.

TABLE 1

| Physical | | | | | Comparative | Comparative | Comparative | Comparative |
|---|---|---|---|---|---|---|---|---|
| property | Example 1 | Example 2 | Example 3 | Example 4 | Example 1 | Example 2 | Example 3 | Example 4 |
| Pencil | 4H | 4H | 4H | 4H | 4H | 3H | 2H | 4H |
| hardness | | | | | | | | |
| Surface | 4.2 × 10¹² | 6.5 × 10¹⁰ | 5.4 × 10¹¹ | 1.1 × 10¹⁰ | 10¹³ or more | 2.3 × 10⁷ | 4.7 × 10¹² | 10¹³ or more |
| resistivity | | | | | (not | | | (not |
| (Ω/square) | | | | | detectable) | | | detectable) |
| Fingerprint | good | good | good | good | good | poor | good | good |
| trace | | | | | | | | |
| removability | | | | | | | | |
| Scribbling | 300 times | 500 times | 600 times | 500 times | 200 times | 100 times | 250 times | 300 times |
| resistance | | | | | | | | |
| (frequency) | | | | | | | | |
| Surface | 13.4 | 13.8 | 13.6 | 13.6 | 13.1 | 14.1 | 13.3 | 13.2 |
| energy | | | | | | | | |
| (mN/m) | | | | | | | | |

As shown in Table 1, it can be seen that the coating film including all of the nano-sized particles and the conductive inorganic particles had more improved abrasion resistance and antistatic property (see Examples 1 to 4, Comparative Example 1, and Comparative Example 3).

In addition, even though the conductive inorganic particles were included, the excessive amount of conductive inorganic particles (Comparative Example 2) problematically reduced the abrasion resistance and contamination resistance. When no (Comparative Example 1) or a small amount (Comparative Example 4) of conductive inorganic particles was included, the antistatic property was found to be poor.

### MODE FOR INVENTION

Hereinafter, the present invention will be described in detail.

The coating composition according to the present invention comprises a) a binder resin containing a UV-curable functional group; b) a compound containing a fluorine UV-curable functional group; c) a photoinitiator; d) nano-sized particles; and e) conductive inorganic particles.

The a) binder resin containing a UV-curable functional group is a main component that is capable of providing the abrasion resistance to a coating film, and the b) compound containing a fluorine UV-curable functional group is a component that is useful to reduce and remove contamination by oil components such as fingerprints.

The a) binder resin containing a UV-curable functional group includes multi-functional or mono-functional monomers or oligomers. It is required that the binder has the high crosslinking density for the improvement of the abrasion resistance, but it needs to appropriately control the density of the binder since cracks or wrong attachment may occur due to the curing shrinkage of the coating film.

The functional group that may be included in the a) binder resin containing a UV-curable functional group is not particularly limited as long as the functional group is UV-curable, and specific examples thereof may include acrylates, methacrylates, vinyls and the like.

Examples of the acrylates include dipentaerythritol hexaacrylate, pentaerythritol tetraacrylate, pentaerythritol triacrylate, tri methylenepropyl triacrylate, ethyleneglycol diacrylate, hexanediol diacrylate, ethyl acrylate, ethylhexyl acrylate, butyl acrylate, hydroxyethyl acrylate and the like.

Examples of the useful acrylate oligomer include a urethane denatured acrylate oligomer, an epoxy acrylate oligomer, an ether acrylate oligomer and the like, and it is preferable that the number of the acrylate functional group is 2 to 6. In connection with this, it is preferable that a molecular weight of the oligomer is in the range of 1,000 to 10,000.

Examples of the methacrylates include trimethylolpropane trimethacrylate, ethyleneglycol dimethacrylate, butanediol dimethacrylate, hexaethyl methacrylate, butyl methacrylate and the like, and a methacrylate oligomer may be used.

Examples of the vinyls include divinyl benzene, styrene, paramethyl styrene and the like.

The b) compound containing a fluorine UV-curable functional group, as a component providing fingerprint trace removability, should include fluorine in order to reduce and remove contamination by oil components such as fingerprints. In addition, it is not particularly limited thereto as long as it has a UV-curable functional group.

In detail, acrylate, methacrylate, and vinyls which include a perfluoro group may be used. In connection with this, it is preferable that the compound containing a fluorine UV-curable functional group has 1 to 6 UV-curable functional groups. In detail, the compound containing a fluorine UV-curable functional group may be selected from the compounds that are represented by the following Formulae 1 to 9, but the scope of the present invention is not limited thereto. If it is a material that has a UV-curable functional group and a fluorine group, it may be used.

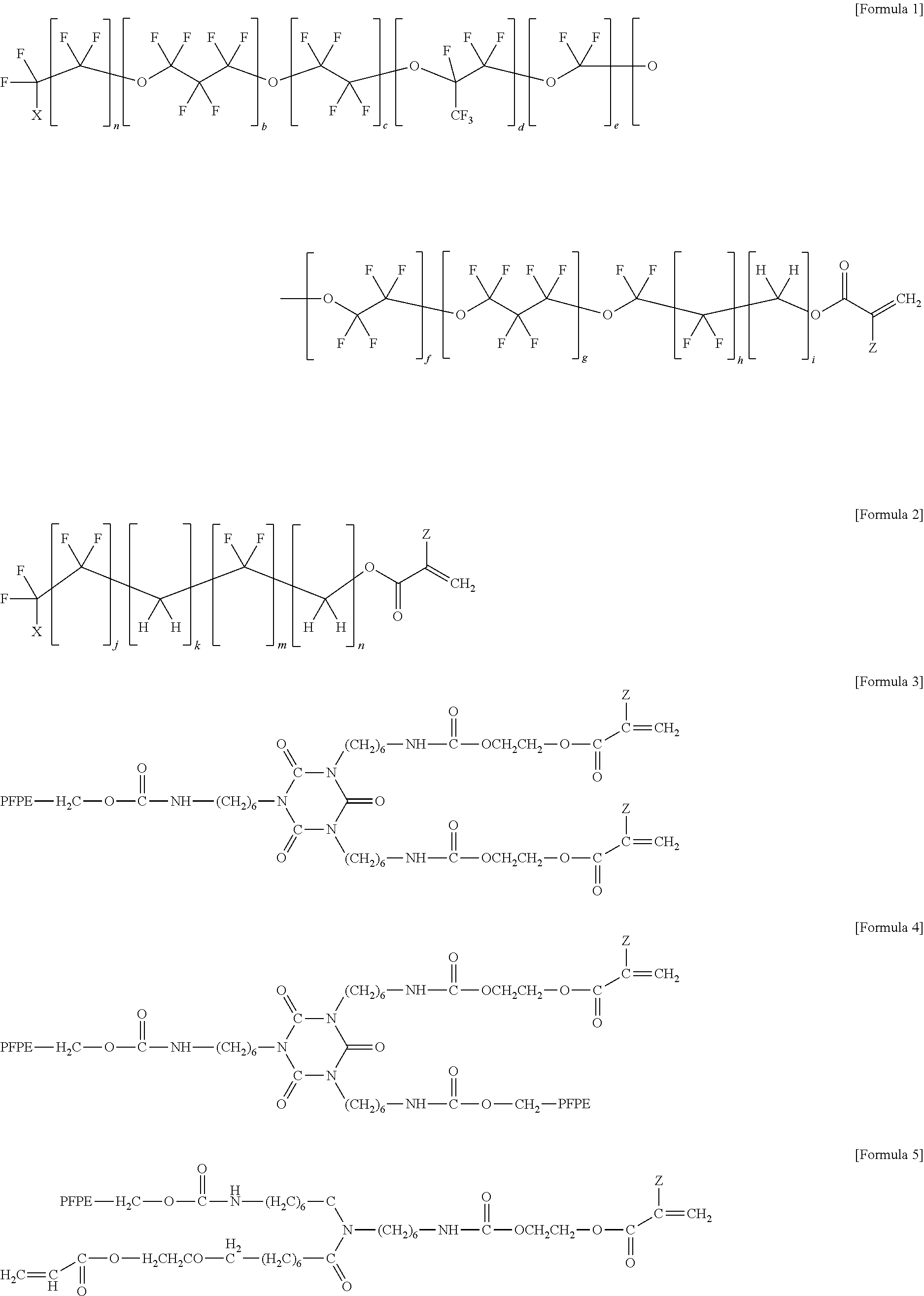

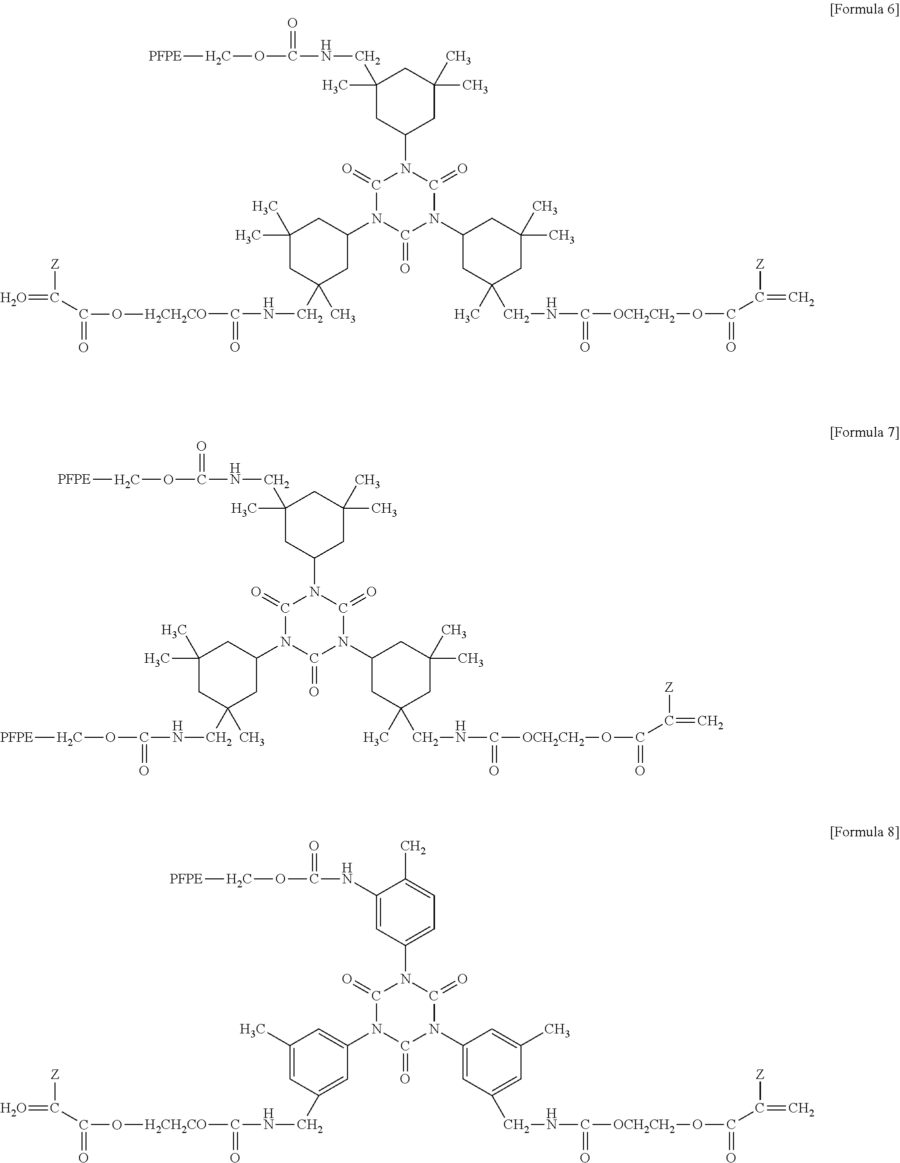

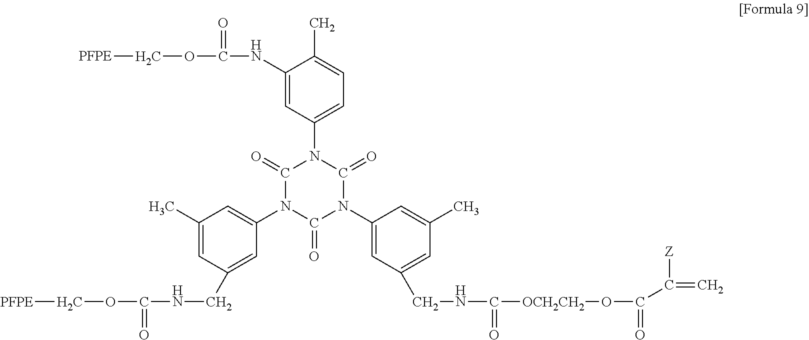

In the above Formulae 1 to 9, X and Y are each independently F or CF₃, Z is H or CH₃, a, j and m are each an integer in the range of 1 to 16, c, k and n are each an integer in the range of 0 to 5, b, d, e, f and g are each an integer in the range of 0 to 200, h and i are each an integer in the range of 0 to 16, and PFPE has the following structure.

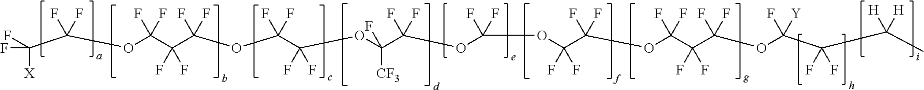

It is preferable that the content of the b) compound containing a fluorine UV-curable functional group is in the range of 0.5 to 20 parts by weight on the basis of 100 parts by weight of the binder resin containing a UV-curable functional group. If the content is less than 0.5 parts by weight, it is difficult to achieve the contamination resistance. If the content exceeds 20 parts by weight, the abrasion resistance may be reduced while the contamination resistance is not further enhanced.

The c) photoinitiator is not particularly limited as long as it is an initiator that is capable of being decomposed by ultraviolet rays. Detailed examples thereof may include Irgacure 127, Irgacure 184, Darocure 1173, and Irgacure 2959 of alpha-hydroxyketones, Irgacure 369, Irgacure 379, Irgacure 907, and Irgacure 1300 of alpha-aminoketones, Irgacure 651 that is benzyl dimethylketal, Darocure TPO that is monoacylphosphine and the like may be used. It is preferable that the content of the c) photoinitiator is in the range of 1 to 20 parts by weight on the basis of 100 parts by weight of the binder resin containing a UV-curable functional group. If the content of the c) photoinitiator is less than 1 part by weight, it is difficult to achieve the abrasion resistance because of a low curing rate. If the content of the c) photoinitiator exceeds 20 parts by weight, the crosslinking density is decreased so that it may result in reduction of the abrasion resistance.

The d) nano-sized particles, as components that impart scribbling resistance to the film in a mixed form with other components of the coating composition according to the present invention, preferably have the average particle size in the range of 0.5 to 50 nm, more preferably in the range of 5 to 50 nm, in order to ensure the optical transparency.

If the particle diameter of the d) nano-sized particles is less than 0.5 nm, the scribbling resistance may be reduced. If the particle diameter is more than 50 nm, an optically opaque coating film may be obtained. In addition, the d) nano-sized particles with the particle diameter of 0.5 nm or more provide excellent scribbling resistance, but the scribbling resistance may be much more enhanced, when the particle diameter is more than 5 nm than when the particle diameter is 0.5 nm.

The d) nano-sized particles may be made of a material selected from silica, alumina, titania, zirconia, magnesium fluoride and the like.

In addition, the d) nano-sized particles may be subjected to the surface treatment in order to improve the compatibility with the a) binder resin containing a UV-curable functional group and the dispersibility of the particles.

For example, the d) nano-sized particles may be subjected to the surface treatment using a material selected from a silane coupling agent, an epoxy compound, a hydroxyl group-containing compound, an isocyanate compound and other dispersing agents.

It is preferable that the content of the d) nano-sized particles is in the range of 0.5 to 50 parts by weight on the basis of 100 parts by weight of the a) binder resin containing a UV-curable functional group. If the content of the d) nano-sized particles is less than 0.5 parts by weight, the scribbling resistance may be reduced. If the content is more than 50 parts by weight, the contamination resistance may be reduced.

The e) conductive inorganic particles, as components that are added to achieve dust removability and antistatic property, preferably have the particle diameter in the range of between 0.5 and 100 nm in order to ensure the optical transparency.

If the particle diameter of the e) conductive inorganic particles is more than 100 nm, an optically opaque coating film may be obtained. If the particle diameter is less than 0.5 nm, the dust removability and the antistatic property may be reduced.

The e) conductive inorganic particles may be formed using a conductive metal oxide filler selected from tin-doped indium oxide (ITO), antimony-doped tin oxide (ATO), antimony-doped zinc oxide (AZO), tin oxide (SnO₂) and zinc oxide (ZnO₂).

In addition, the e) conductive inorganic particles may be subjected to the surface treatment in order to improve the compatibility with the a) binder resin containing a UV-curable functional group and the dispersibility of the particles.

For example, the e) conductive inorganic particles may be subjected to the surface treatment using a material selected from a silane coupling agent, an epoxy compound, a hydroxyl group-containing compound, an isocyanate compound and other dispersing agents.

It is preferable that the content of the e) conductive inorganic particles is in the range of more than 0.5 to 50 or less parts by weight on the basis of 100 parts by weight of the a) binder resin containing a UV-curable functional group. If the content is 0.5 or less parts by weight, it is difficult to achieve the dust removability. If the content is more than 50 parts by weight, the contamination resistance may be reduced.

The coating composition according to the present invention may further include a solvent for a coating property in addition to the above components. The kind and content of the solvent are not particularly limited, but for the coating property, the solvent is preferably used in the range of 10 to 1000 parts by weight on the basis of 100 parts by weight of the a) binder resin containing a UV-curable functional group.

Alcohols, alkanes, ethers, cycloalkanes, aromatic organic solvents or the like may be used as the solvent. In detail, methanol, ethanol, isopropyl alcohol, butanol, ethylene glycol, diacetone alcohol, 2-ethoxy ethanol, 2-methoxy ethanol, 2-butoxy ethanol, propyleneglycol monomethyl ether, hexane, heptane, cyclohexane, acetyl acetone, dimethyl ketone, methyl ethyl ketone, methyl isobutyl ketone, toluene, benzene, xylene, methyl acetate, ethyl acetate, butyl acetate, dimethyl formamide, tetrahydrofurane and the like may be applied, but the scope of the present invention is not limited thereto.

The coating composition according to the present invention may be coated on a substrate. The substrate is not particularly limited, but a plastic film may be used. The film may include polyester, triacetyl cellulose, an olefin copolymer and polymethyl methacrylate.

The coating composition may be coated on a substrate by using a coating method that is generally known in the art, and examples of the type of the coating method include two-roll or three-roll reverse coating, gravure coating, micro gravure coating, die coating, curtain coating, bar coating, dip coating, and flow coating and the like.

It is preferable that the film coated by using the above method is cured by irradiation of ultraviolet rays in an amount of 0.05 to 2 J/cm² after drying, and particularly, when it is cured under a nitrogen atmosphere, the fingerprint trace removability may be improved since the degree of surface curing is increased.

The coating thickness of the coating composition is preferably in the range of 0.5 to 300 μm and more preferably 10 to 300 μm. When the coating thickness is increased, the abrasion resistance is improved, but a winding phenomenon of the film or cracks may occur due to the curing shrinkage.

Meanwhile, the coating film according to the present invention is prepared by using the coating composition according to the present invention so that it may comprise a) a binder resin containing a UV-curable functional group; b) a compound containing a fluorine UV-curable functional group; c) a photoinitiator; d) nano-sized particles; and e) conductive inorganic particles. All of the descriptions in the embodiment are also applied herein.

The coating film that is prepared by using the coating composition according to the present invention has excellent abrasion resistance, and excellent contamination resistance such as fingerprint trace removability and scribbling resistance to easily remove contaminants of oil components such as fingerprints or scribbles, and in particular, excellent dust removability.

The thickness of the coating film according to the present invention is preferably 0.5 to 30 μm, and more preferably 10 to 30 μm.

In addition, a substrate may be provided on at least one side of the coating film according to the present invention.

The coating film according to the present invention may be applied without being limited as long as there are need for the abrasion resistance and the contamination resistance. For example, it may be applied to display devices. The coating film may be directly coated on parts of the object devices such as display devices, or may be applied to the object devices in conjunction with the substrate after it is formed on the substrate. The coating film according to the present invention may be applied to a liquid crystal display, an organic light emitting display (OLED), and a plasma display panel (PDP), but the scope of the present invention is not limited thereto.

Meanwhile, the method for producing a coating film according to the present invention may comprise the steps of coating the coating composition according to the present invention on a substrate; and drying and photocuring the coated coating composition. All of the descriptions in the embodiment are also applied herein.

Meanwhile, the display device according to the present invention may comprise any one selected from a liquid crystal display (LCD), an organic light emitting display (OLED), and a plasma display panel (PDP); and the coating film according to the present invention.

Herein, the coating film formed by coating a substrate with the coating composition may be attached to the display device, or the display device may be directly coated with the coating composition.

Specifically, in order to impart the contamination resistance and abrasion resistance, the coating film formed by coating a substrate with the coating composition may be detachably used in the displays such as mobile phone window or laptop or may be attached to display devices such as a polarizer or a PDP filter.

Examples of the display devices according to the present invention may include displays such as TVs, monitors for computers, laptops, mobile phones and the like, but are not limited thereto.

Specifically, the TVs, monitors for computers, and mobile phones may include a display device; and the coating film according to the present invention that is provided on the surface of the display device. In addition, the display device may be supported by a main body case that forms the external appearance of TVs, monitors for computers, and mobile phones.

The laptop may include a computer main body; and a display main body that is rotatably mounted to the computer main body, and the display main body may include a display device forming images and the coating film according to the present invention that is provided on the surface of the display device. The display device may be supported by a main body case that forms the external appearance of the display main body.

1. A coating composition comprising:
a) a binder resin containing a UV-curable functional group;
b) a compound containing a fluorine UV-curable functional group;
c) a photoinitiator;
d) nano-sized particles; and
e) conductive inorganic particles.

2. The coating composition according to claim 1, wherein the e) conductive inorganic particles is contained in the range of more than 0.5 to 50 or less parts by weight on the basis of 100 parts by weight of the a) binder resin containing a UV-curable functional group.

3. The coating composition according to claim 1, wherein on the basis of 100 parts by weight of the a) binder resin containing a UV-curable functional group, the content of the b) compound containing a fluorine UV-curable functional group is in the range of 0.5 to 20 parts by weight, the content of the c) photoinitiator is in the range of 1 to 20 parts by weight, the content of the d) nano-sized particles is in the range of 0.5 to 50 parts by weight, and the content of the e) conductive inorganic particles is in the range of more than 0.5 to 50 or less parts by weight.

4. The coating composition according to claim 1, wherein the a) binder resin containing a UV-curable functional group includes multi-functional or mono-functional monomers or oligomers of acrylates, methacrylates, or vinyls.

5. The coating composition according to claim 1, wherein the b) compound containing the fluorine UV-curable functional group includes a compound selected from acrylates, methacrylates and vinyls containing a perfluoro group.

6. The coating composition according to claim 1, wherein the b) compound containing a fluorine UV-curable functional group includes a compound selected from the compounds that are represented by the following Formulae 1 to 9: 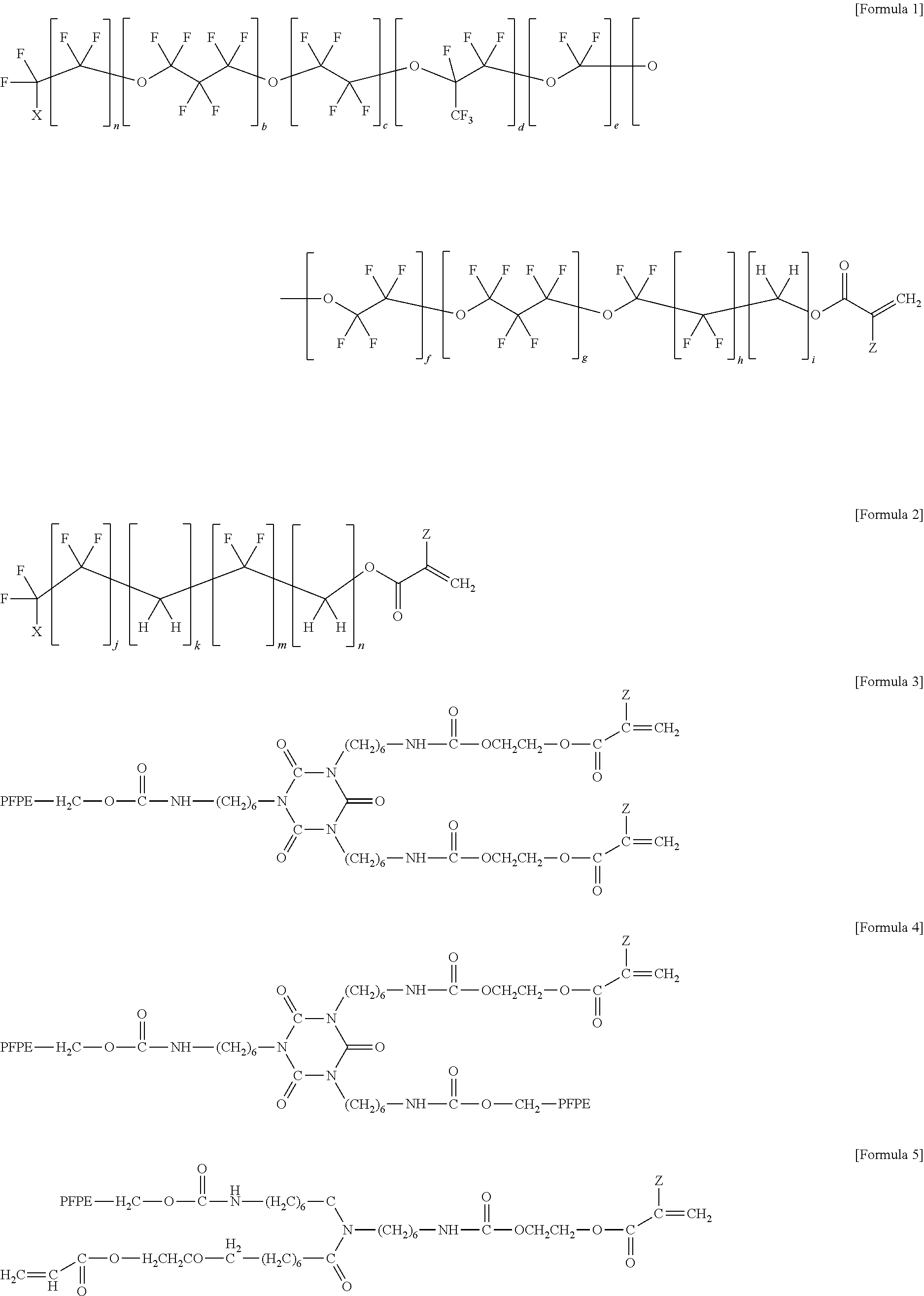 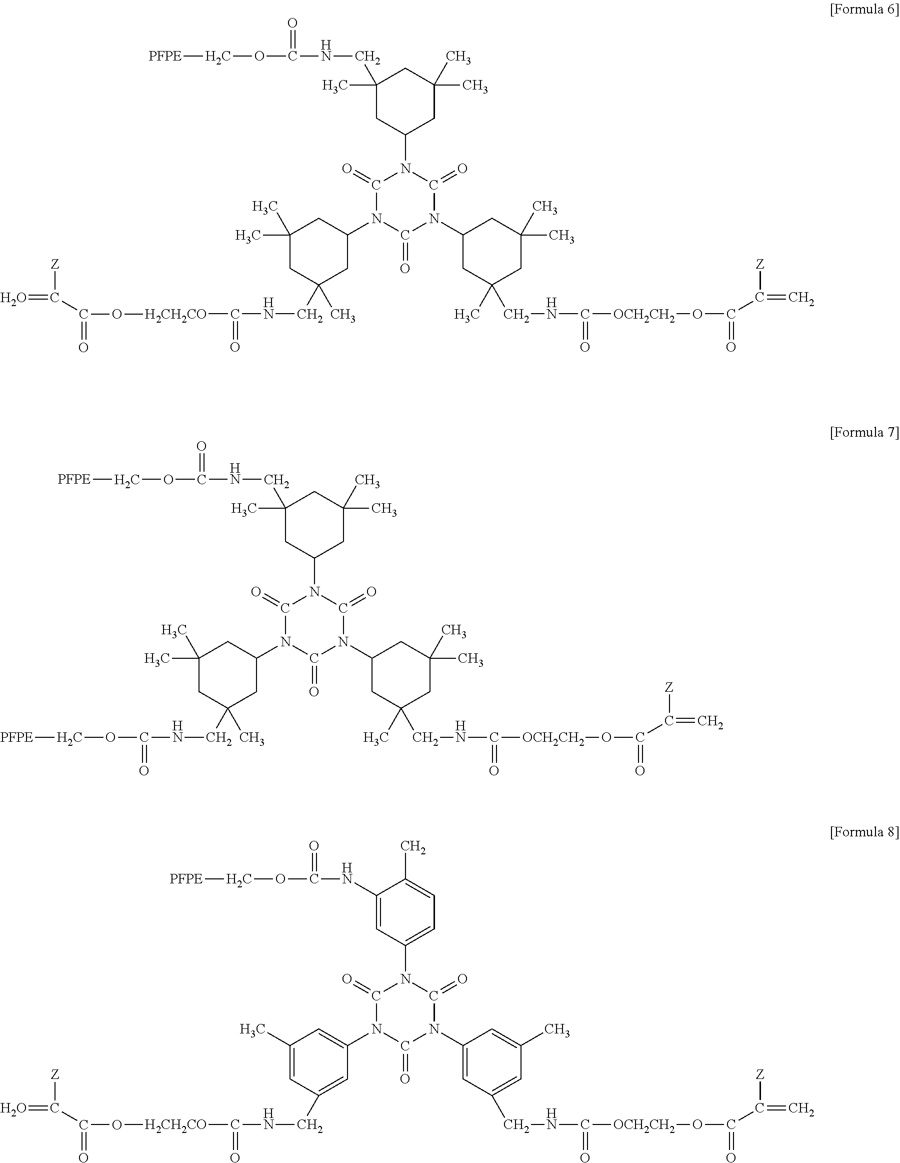 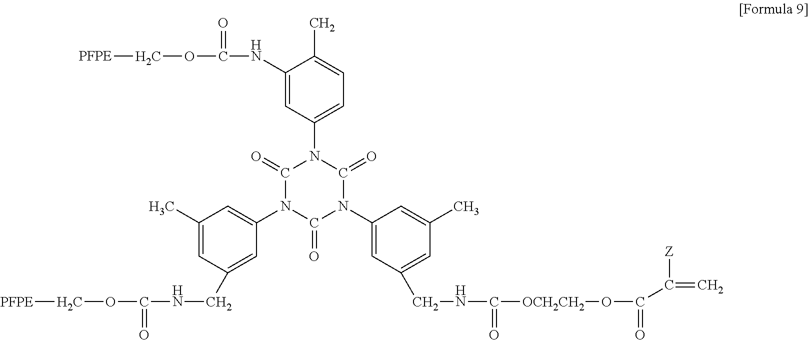
in which Formulae 1 to 9, X and Y are each independently F or CF₃, Z is H or CH₃, a, j and m are each an integer in the range of 1 to 16, c, k and n are each an integer in the range of 0 to 5, b, d, e, f and g are each an integer in the range of 0 to 200, h and i are each an integer in the range of 0 to 16, and PFPE has the following structure.

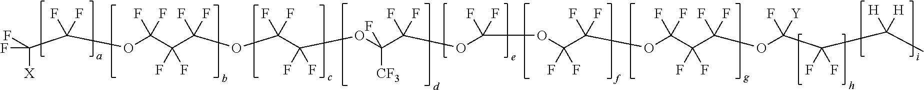

7. The coating composition according to claim 1, wherein a particle diameter of the d) nano-sized particles is in the range of 0.5 to 50 nm.

8. The coating composition according to claim 1, wherein the d) nano-sized particles are selected from silica, alumina, titania, zirconia and magnesium fluoride.

9. The coating composition according to claim 1, wherein the d) nano-sized particles are subjected to surface treatment by using a material selected from a silane coupling agent, an epoxy compound, a hydroxyl group-containing compound and an isocyanate compound.

10. The coating composition according to claim 1, wherein a particle diameter of the e) conductive inorganic particles is in the range of 0.5 to 100 nm.

11. The coating composition according to claim 1, wherein the e) conductive inorganic particles are formed using a material selected from tin-doped indium oxide (ITO), antimony-doped tin oxide (ATO), antimony-doped zinc oxide (AZO), tin oxide (SnO₂) and zinc oxide (ZnO₂).

12. The coating composition according to claim 1, wherein the e) conductive inorganic particles are subjected to surface treatment by using a material selected from a silane coupling agent, an epoxy compound, a hydroxyl group-containing compound and an isocyanate compound.

13. The coating composition according to claim 3, further comprising 10 to 1000 parts by weight of a solvent on the basis of 100 parts by weight of the a) binder resin containing a UV-curable functional group.

14. A coating film prepared by using the coating composition according to claim 1, comprising: a) a binder resin containing a UV-curable functional group; b) a compound containing a fluorine UV-curable functional group; c) a photoinitiator; d) nano-sized particles; and e) conductive inorganic particles.

15. The coating film according to claim 14, wherein the thickness of the film is in the range of 0.5 to 300 μm.

16. The coating film according to claim 14, wherein a substrate is provided on at least one side of the coating film.

17. The coating film according to claim 16, wherein the substrate is made of a material selected from polyester, triacetyl cellulose, an olefin copolymer and polymethyl methacrylate.

18. A method for producing a coating film, comprising the steps of coating the coating composition according to claim 1 on a substrate; and drying and photocuring the coated coating composition.

19. The method according to claim 18, wherein the substrate is made of a material selected from polyester, triacetyl cellulose, an olefin copolymer and polymethyl methacrylate.

20. The method according to claim 18, wherein the coating thickness of the coating composition is in the range of 0.5 to 300 μm.

21. The method according to claim 18, wherein the photocuring is performed by using irradiation of ultraviolet rays in an amount in the range of 0.05 to 2 J/cm².

22. A display device comprising the coating film according to claim 14.

23. The display device according to claim 22, wherein the display device includes any one of a liquid crystal display (LCD), an organic light emitting display (OLED), and a plasma display panel (PDP).
